(19) United States
(12) Patent Application Publication
(10) Pub. No.: US 2022/0292461 A1
(43) Pub. Date: Sep. 15, 2022

(54) SYSTEM AND METHOD FOR PROGRAMMATIC EMPLOYMENT ADVERTISING

(71) Applicant: Pandologic Ltd, Kfar Saba (IL)

(72) Inventors: Yigal GOLDFINE, Kfar Saba (IL); Amir KALDOR, Kfar Saba (IL)

(73) Assignee: Pandologic Ltd

(21) Appl. No.: 17/200,762

(22) Filed: Mar. 12, 2021

(51) Int. Cl. G06Q 10/10; G06F 16/906; G06F 16/9035; G06F 16/9038

(52) U.S. Cl. CPC G06Q 10/1053; G06F 16/906; G06F 16/9035; G06F 16/9038

(57) ABSTRACT

A system and method for programmatically testing a plurality of employment posting variants in a systematic and hierarchical manner, while being guided by current and historical employment posting data, including with regard to costs and success rate. According to at least some embodiments, the system first creates a plurality of different job posting title and text variants, as an expanded set of job postings or “expansion”. Optionally particular feature(s) are selected for expansion, such as for example job posting location or geography, job title, description and so forth. Such particular feature(s) may be selected according to historical data. Optionally all expanded job postings are considered for testing, but alternatively, the set of job postings may be initially limited according to an analysis of historical data. Each job posting may be associated with a bid and publisher selection to form a job cluster, but if not, then bid and publisher selection is preferably also performed according to historical data.

### FIELD OF THE INVENTION

The present invention relates to a system and method for programmatic employment advertising, and in particular, to such a system and method for testing a plurality of advertising variants in a systematic and hierarchical manner.

### BACKGROUND OF THE INVENTION

Job postings are required to find and hire suitable employees for various positions. Sometimes hiring occurs in bulk, for example when a new warehouse or other work center is opened, and/or seasonally (for example before the Christmas gift and package rush). In other cases, there may be an ongoing need for certain categories of workers, whether due to turnover and/or because some categories of workers are in high demand relative to supply. Currently, job postings are typically published online. While this increases convenience, it can also result in wasted time and money for employers due to non-suitable applicants.

Unlike other types of advertisements, job postings have greater, more complex requirements and publication parameters. Furthermore, the consequences of poor job posting strategy are likely to be higher than for normal consumer advertising strategy, for example. Unfortunately, there aren't currently any suitable tools which solve this problem specifically and effectively for job postings.

### BRIEF SUMMARY OF THE INVENTION

The background art does not teach or suggest a system or method for programmatically testing a plurality of employment posting variants in a systematic and hierarchical manner. The background art also does not teach or suggest a system or method for applying current and historical employment posting data, including with regard to costs and success rate, to such systematic testing.

The present invention overcomes the drawbacks of the background art by providing, in at least some embodiments, a system and method for programmatically testing a plurality of employment posting variants in a systematic and hierarchical manner, while being guided by current and historical employment posting data, including with regard to costs and success rate. According to at least some embodiments, the system first creates a plurality of different job posting title and text variants, as an expanded set of job postings or “expansion”. Optionally particular feature(s) are selected for expansion, such as for example job posting location or geography, job title, description and so forth. Such particular feature(s) may be selected according to historical data. Optionally all expanded job postings are considered for testing, but alternatively, the set of job postings may be initially limited according to an analysis of historical data. Each job posting may be associated with a bid and publisher selection to form a job cluster, but if not, then bid and publisher selection is preferably also performed according to historical data.

Expanded job postings are then grouped into tiers. The alpha tier relates to the currently most successful job posting strategy or strategies, while gamma tier job postings are variants on the job posting(s) in the alpha tier. Job postings in the beta tier are preferably regularly tested; if one or more proves to be more successful than an alpha tier job posting, the beta tier job posting is moved up to the alpha tier, while the alpha tier job posting is removed. Gamma tier job postings that are associated with the newly removed alpha tier job posting are also removed. New job postings that are associated with the newly promoted alpha tier job posting, as variants, are added to the gamma tier.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality. Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a tablet or phablet, including without limitation an iPad, a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIGS. 1A-1C relate to exemplary, illustrative, non-limiting systems according to at least some embodiments of the present invention;

FIG. 1D relates to an exemplary, illustrative, non-limiting method according to at least some embodiments of the present invention;

FIGS. 2A and 2B relate to exemplary, illustrative, non-limiting analysis engines, for example for implementation with the system of any of FIGS. 1A-1C, according to at least some embodiments of the present invention;

FIG. 3 relates to an exemplary, non-limiting method for job posting expansion and publication according to at least some embodiments;

FIG. 4 relates to an exemplary, non-limiting detailed method for job posting expansion according to at least some embodiments;

FIG. 5A relates to a non-limiting exemplary AI engine, which may be incorporated with the AI engine of FIG. 5B and which may also provide inputs to the analysis engine;

FIG. 5B relates to an additional non-limiting exemplary AI engine, which may be incorporated with the AI engine of FIG. 5A and which may also provide inputs to the analysis engine;

FIG. 6 relates to an exemplary, non-limiting method for creating an expanded set of hierarchically ordered job postings;

FIG. 7 relates to an exemplary, non-limiting method for arranging job postings within the hierarchy; and

FIG. 8 relates to an exemplary, non-limiting method for creating multiple job postings.

DESCRIPTION OF AT LEAST SOME EMBODIMENTS

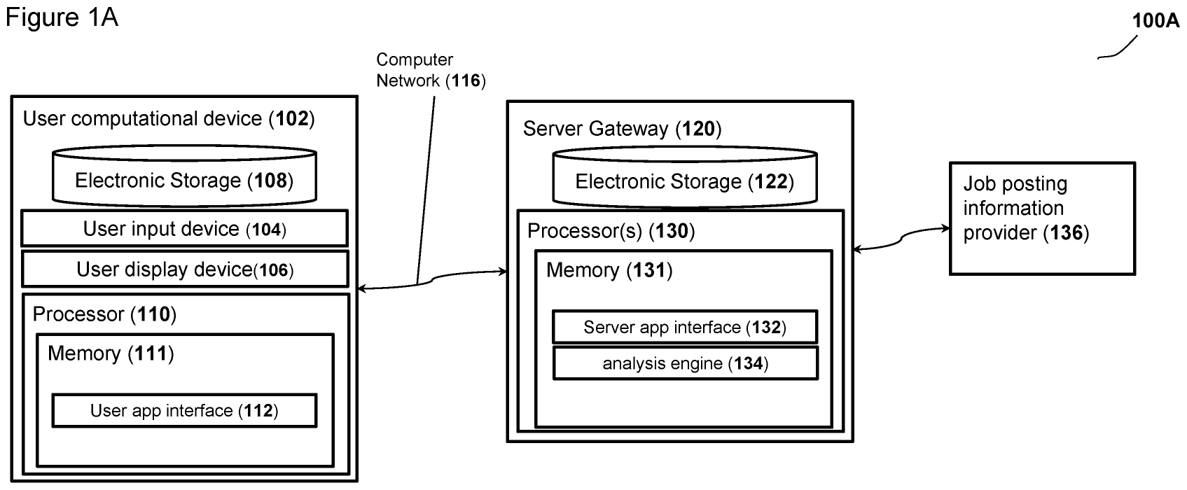

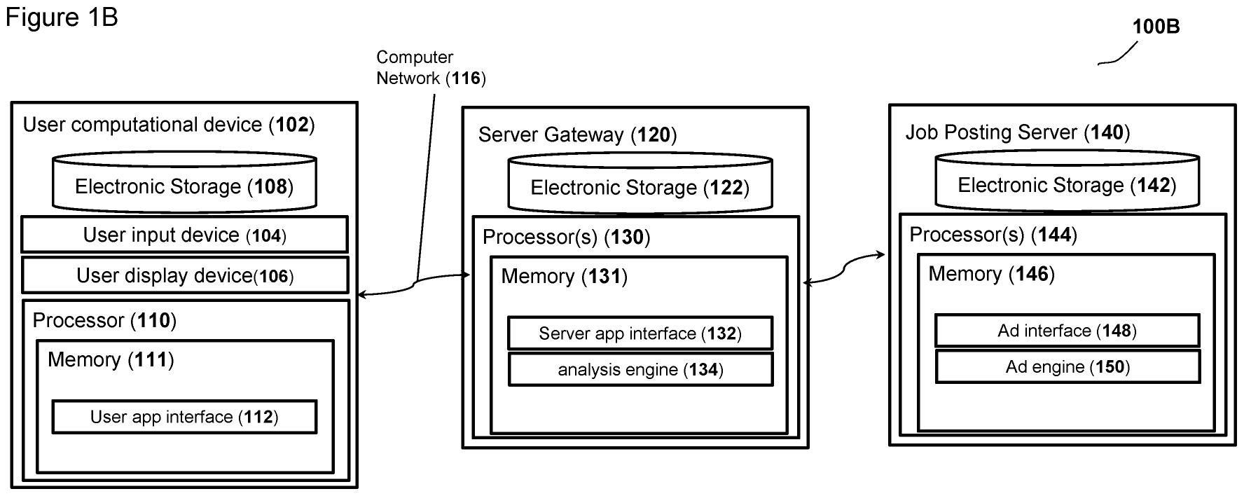

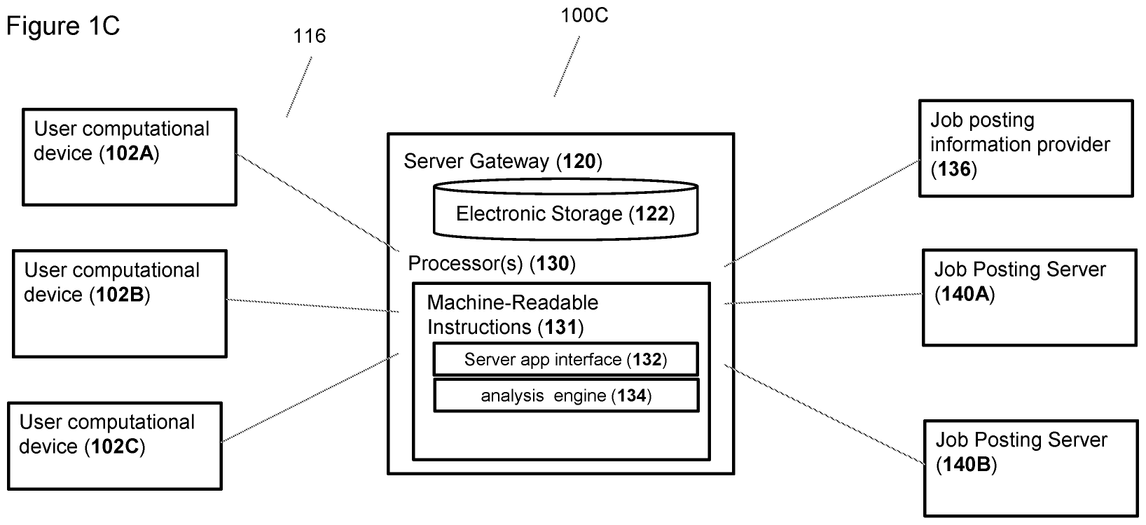

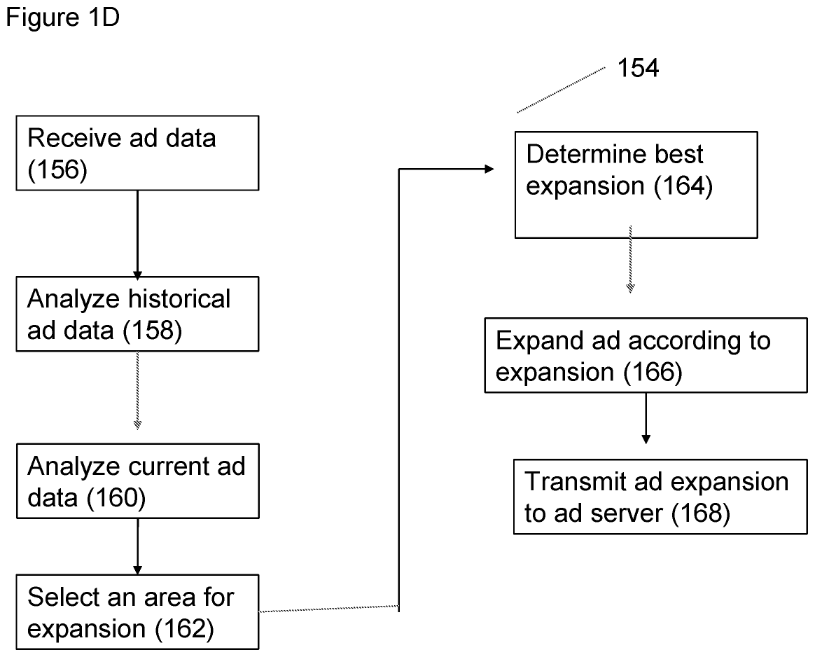

FIGS. 1A-1C relate to exemplary, illustrative, non-limiting systems according to at least some embodiments of the present invention. FIG. 1A shows an exemplary system 100A, featuring a user computational device 102 for being operated by a job posting creator user. As shown in the system 100A, there is provided a user computational device 102 in communication with the server gateway 120 through a computer network 116 such as the internet for example.

User computational device 102 includes the user input device 104, the user app interface 112, and user display device 106. The user input device 104 may optionally be any type of suitable input device including but not limited to a keyboard, microphone, mouse, or other pointing device and the like. Preferably user input device 104 includes a list, a microphone and a keyboard, mouse, or keyboard mouse combination.

User display device 106 is able to display information to the user for example from user app interface 112. The user operates user app interface 112 to provide job posting information and/or guidelines to an analysis engine 134 being operated by server gateway 120. This information is taken in from user app interface 112 through the server app interface 132. Analysis engine 134 preferably also has access to historical and optionally also real time job posting information, including with regard to publisher parameters, job posting success rates and bid prices. Such information may be stored at an electronic storage 122 associated with server gateway 120, may be provided through a job posting information provider 136 or from another source (not shown). Analysis engine 134 preferably provides the systematic, hierarchical job posting test process, in which a plurality of different job postings are tested; those postings which are successful move up the hierarchy, while the remainder are downgraded. Optionally each tested job posting is associated with a plurality of expansions. Each such expansion preferably relates to a plurality of variations on job title and job description, as well as job location. Optionally job location information is placed in the job title and/or job description, but may also be placed separately for publication, for example according to the format of the job posting publisher.

Also optionally, each tested job posting features associated publisher information, for example with regard to the total number of postings, job posting frequency, job posting timing, job posting location and/or position on a particular publication, including without limitation on a search results page; and so forth. Also optionally, each tested job posting features associated bid information, for example with regard to bid price, bid price range, any optional variations on bid price (for example with regard to timing during the day and/or week), and also optionally any connection between bid information and each publisher under consideration. Also optionally, each tested job posting features associated result information, for example with regard to the number of clicks, number of applicants, click to applicant ratio, click rate, applicant rate, cost per click, cost per applicant, number of hires, rate of hires, hire to applicant or hire to click ratio, cost per hire.

The analyzed and selected job posting expansions may be sent directly to one or more publishers for publishing (not shown). Alternatively or additionally the job posting expansions may be provided to user computational device 102, which in turn may then be directed by the user for transfer to one or more publishers for publishing (not shown).

User computational device 102 also comprises a processor 110 and a memory 111. Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 111 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 is configured for storing a defined native instruction set of codes. Processor 110 is configured to perform a defined set of basic operations in response to receiving a corresponding basic instruction selected from the defined native instruction set of codes stored in memory 111. For example and without limitation, memory 111 may store a first set of machine codes selected from the native instruction set for receiving information and/or instructions from the user through user app interface 112 and a second set of machine codes selected from the native instruction set for transmitting such information to server gateway 120.

Similarly, server gateway 120 preferably comprises a processor 130 and a memory 131 with related or at least similar functions, including without limitation functions of server gateway 120 as described herein. For example and without limitation, memory 131 may store a first set of machine codes selected from the native instruction set for receiving information and/or instructions from user computational device 102, and a second set of machine codes selected from the native instruction set for executing functions of analysis engine 134. Memory 131 may store a third set of machine codes selected from the native instruction set for receiving historical and/or current job posting information from job posting information provider 136, for supply to analysis engine 134.

Optionally, historical and/or current job posting information, and/or previously performed analysis to determine job posting expansions, may be stored at an electronic storage 108 at user computational device 102 and/or at electronic storage 122 of server gateway 120.

FIG. 1B shows an exemplary system 100B. Components with the same reference number may have an identical or similar function as for FIG. 1A. System 100B features a job posting server 140 for receiving job postings, preferably with associated bid and/or publisher information, from analysis engine 134. Job posting server 140 may comprise a publisher network, in which case each publisher on the network may be separately identified and provided with a set of the above information that is specific to each such publisher. Optionally current and/or historical job posting information as described herein is provided by job posting information provider 136 (not shown) and/or by job posting server 140.

Job posting server 140 preferably comprises an ad engine 150 and an ad interface 148. Ad engine 150 preferably causes job postings to be published, according to information received from ad interface 148. Ad interface 148 preferably receives the job posting information from server gateway 120, according to the output of analysis engine 134, but alternatively receives the information from user computational device 102.

Job posting server 140 preferably comprises a processor 144 and a memory 146 with related or at least similar functions, including without limitation functions of job posting server 140 as described herein. For example and without limitation, memory 146 may store a first set of machine codes selected from the native instruction set for receiving information and/or instructions from server gateway 120, and a second set of machine codes selected from the native instruction set for executing functions of ad engine 150. Memory 146 may store a third set of machine codes selected from the native instruction set for providing historical and/or current job posting information to server gateway 120, for supply to analysis engine 134.

Information about previous job postings and their performance may be stored at electronic storage 142.

FIG. 1C shows an exemplary system 100C. Components with the same reference number may have an identical or similar function as for FIGS. 1A and/or 1B. Details from the components shown in FIGS. 1A and/or 1B may be assumed to be present, even if not shown, unless otherwise indicated. System 100C features a plurality of user computational devices 102A-102C as a non-limiting exemplary number, for preferably sending guidance and/or instructions to server gateway 120 and/or one or more other components shown, and preferably also for receiving job posting performance information from server gateway 120 and/or one or more other components shown. A plurality of job posting servers 140 are shown as 140A and 140B, without any intention of being limiting. Optionally one or more job posting server 140 comprises a job posting publisher network as described herein. Analysis engine 134 preferably receives current and/or historical job information from job posting information provider 136 and/or from one or more job posting server 140 for determining current and predicted job posting performance. Analysis engine 134 also preferably determines the job posting tests and selected expansions according to such performance.

FIG. 1D relates to an exemplary, illustrative, non-limiting method according to at least some embodiments of the present invention. As shown, a method 154 preferably begins by receiving ad (job posting) information at 156. Historical job posting information is analyzed at 158 while current job posting information is analyzed at 160. Optionally both types information are analyzed together. The analysis preferably includes performance at each publisher, bid price information and also performance of each alpha tier job posting and its associated expansions.

New or adjusted expansions may be determined according to the next steps, for example for a new job posting campaign and/or for an adjustment of a current job posting campaign. Optionally all such expansions are determined in advance of the start of the new or adjusted job posting campaign; alternatively, one or more areas are selected for focusing the expansion and these selected area(s) are then expanded. The latter method is shown herein but the former may be performed.

As shown at 162, an area is selected for expansion for job postings, for example with regard to job title and/or job text. Optionally associated publisher selection and publisher information are also considered for association with the expansion, as is bid price. The best set of expansions is preferably determined at 164, for example according to the current and/or historical job posting information. The job posting is then expanded according to that preferred expansion criteria at 166 and the job expansion is transmitted to the server gateway at 168.

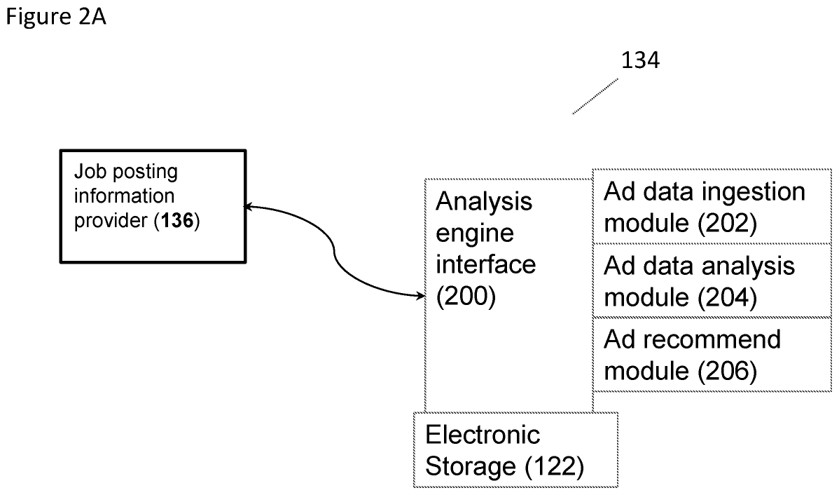

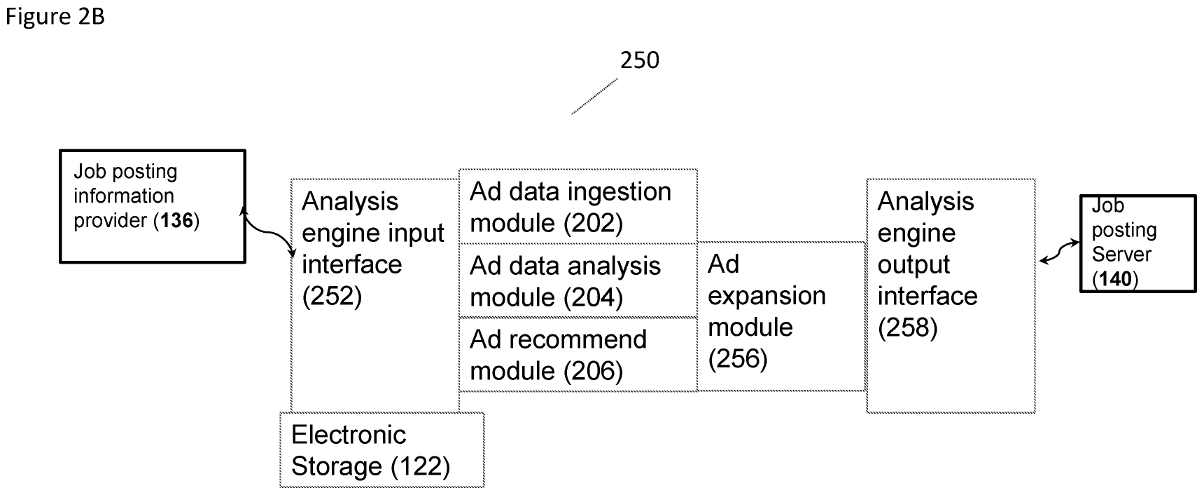

FIG. 2A relates to an exemplary, illustrative, non-limiting analysis engine, for example for implementation with the system of any of FIGS. 1A-1C, according to at least some embodiments of the present invention. As shown in a detailed implementation of analysis engine 134, an analysis engine interface 200 preferably receives a plurality of data inputs for analysis and then also provides the output result. Data inputs for analysis, related to job posting information, are received by an ad data ingestion module 202, preferably from job posting information provider 136. Such data preferably includes bid price, frequency and timing of job posting information by publisher, for historical and optionally also current job postings. Ad data ingestion module 202 preferably performs any necessary preprocessing.

After preprocessing, data is then fed to an ad data analysis module 204. Ad data analysis module 204 preferably determines which alpha tier job posting is still top performing and also whether to swap out an alpha tier job posting for a beta tier job posting. Performance may be considered with regard to bid price, number of applicants applying for a job posting, rate of applicants applying, and number and/or rate of qualified applicants applying. Optionally performance is considered with regard to one or more historically trained models and/or according to one or more rules or guidelines.

Ad data analysis module 204 may retrieve additional information from, or store analysis results at electronic storage 122.

An ad recommendation module 206 preferably then receives the analysis from ad data analysis module 204 and prepares one or more output actions as previously described. Preferably, such output actions relate to adjusting one or more of job title, job description, selected publisher, publisher parameters such as number, frequency and/or timing of job posting publication, and/or bid price.

FIG. 2B relates to an additional embodiment of the analysis engine, shown as an analysis engine 250. Components with the same reference numbers as FIG. 2A have the same or similar function, unless otherwise indicated. Analysis engine 250 comprises an analysis engine input interface 252 for receiving data inputs for analysis, related to job posting information, preferably from job posting information provider 136 as described for FIG. 2A. After processing and analysis by ad data ingestion module 202, ad data analysis module 204 and ad recommend module 206, for example as described with regard to FIG. 2A, the job postings are expanded as described herein by an ad expansion module 256. The expanded job postings, preferably with bidding and publisher information, are then preferably output through an analysis engine output interface 258 to Job posting Server 140.

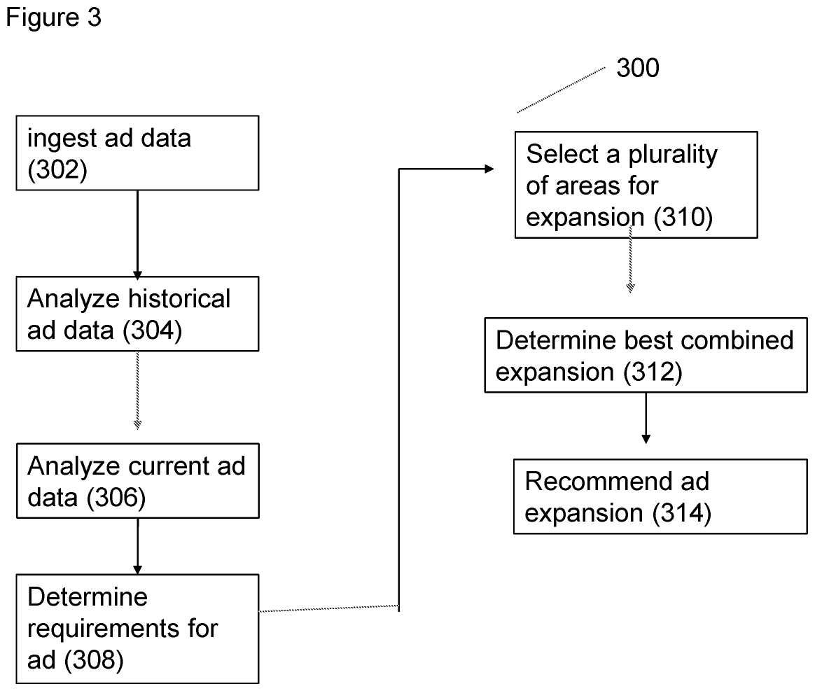

FIG. 3 relates to an exemplary, non-limiting method for job posting expansion and publication according to at least some embodiments. As shown in a method 300, the process begins with ingesting ad (job posting) data at 302. The ad data preferably includes information about the job posting titles and descriptions, and more preferably also includes bidding and publisher information. The information included may relate to a plurality of variations on job title and job description, as well as job location. Optionally job location information is placed in the job title and/or job description, but may also be placed separately for publication, for example according to the format of the job posting publisher.

Also optionally, the job posting information features associated publisher information, for example with regard to the total number of postings, job posting frequency, job posting timing, job posting location and/or position on a particular publication, including without limitation on a search results page; and so forth. Also optionally, the job posting information features associated bid information, for example with regard to bid price, bid price range, any optional variations on bid price (for example with regard to timing during the day and/or week), and also optionally any connection between bid information and each publisher under consideration. Also optionally, the job posting information features associated result information, for example with regard to the number of clicks, number of applicants, click to applicant ratio, click rate, applicant rate, cost per click, cost per applicant, number of hires, rate of hires, hire to applicant or hire to click ratio, cost per hire.

At 304, historical ad (job posting) data is analyzed, according to the above information, for example to consider trends with regard to any of the above items, including without limitation job title and/or description performance, bidding information and/or publisher performance. At 306, current ad (job posting) data is preferably similarly analyzed.

At 308, the requirements for the ad (job posting) are determined, for example by determining the job posting titles and descriptions, and more preferably also the bidding and publisher requirements, for example optionally by filling in relevant information according to the template provided by historical job posting data. Alternatively, such information may optionally be manually provided.

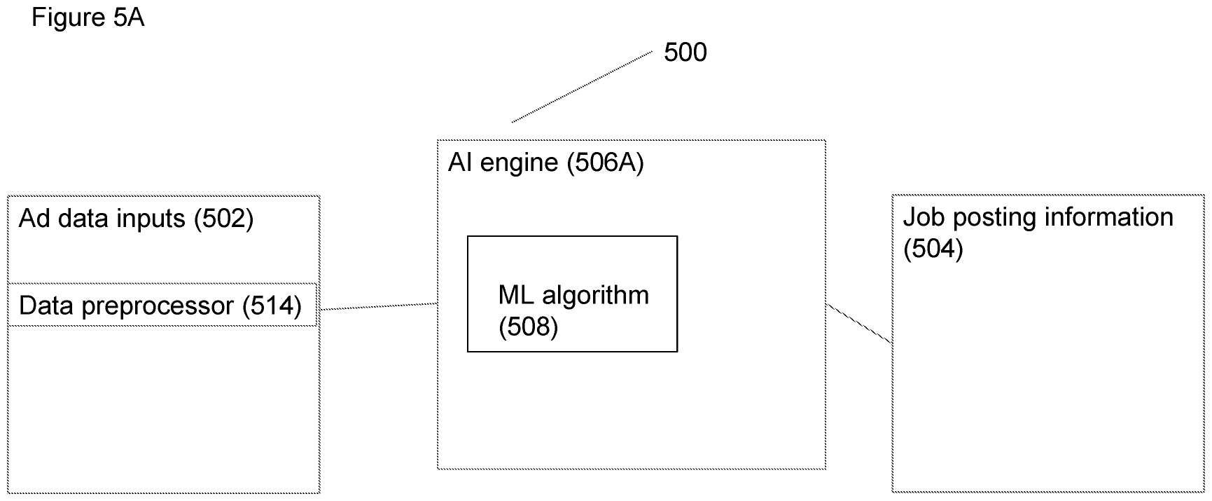

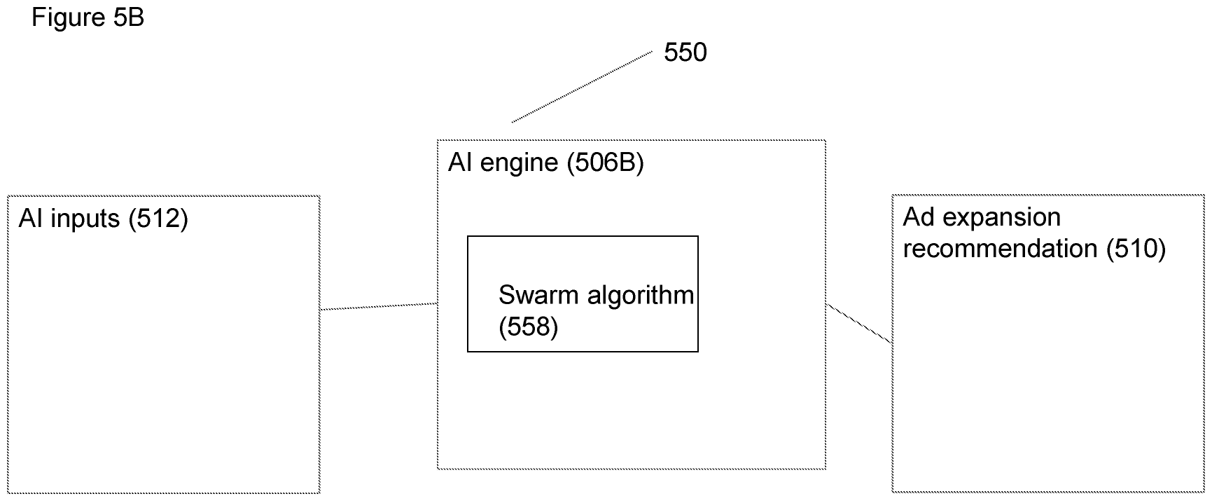

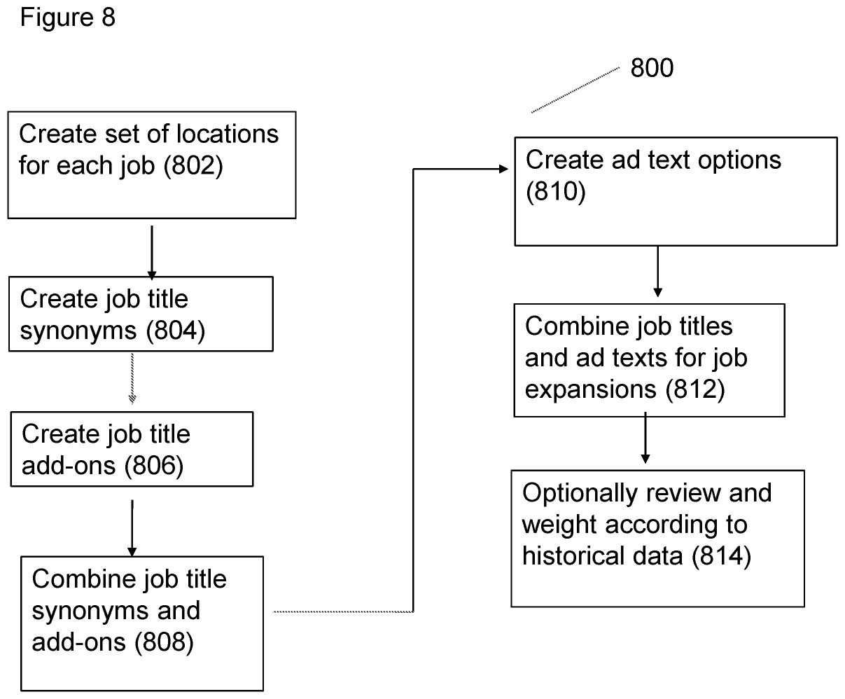

Next, at 310, a plurality of job posting areas are selected for expansion, for example and without limitation, job title and job description variations. Preferably multiple such variations are determined, as described for example with regard to FIG. 8. At 312, the best combined expansion is determined, at least for an initial set of job postings. Such a best combined expansion is preferably determined according to the machine learning (ML) algorithm of FIG. 5A. Optionally a best combined expansion is determined according to manually provided information and/or historical job posting data.

At 314, a recommended ad (job posting) expansion is provided.

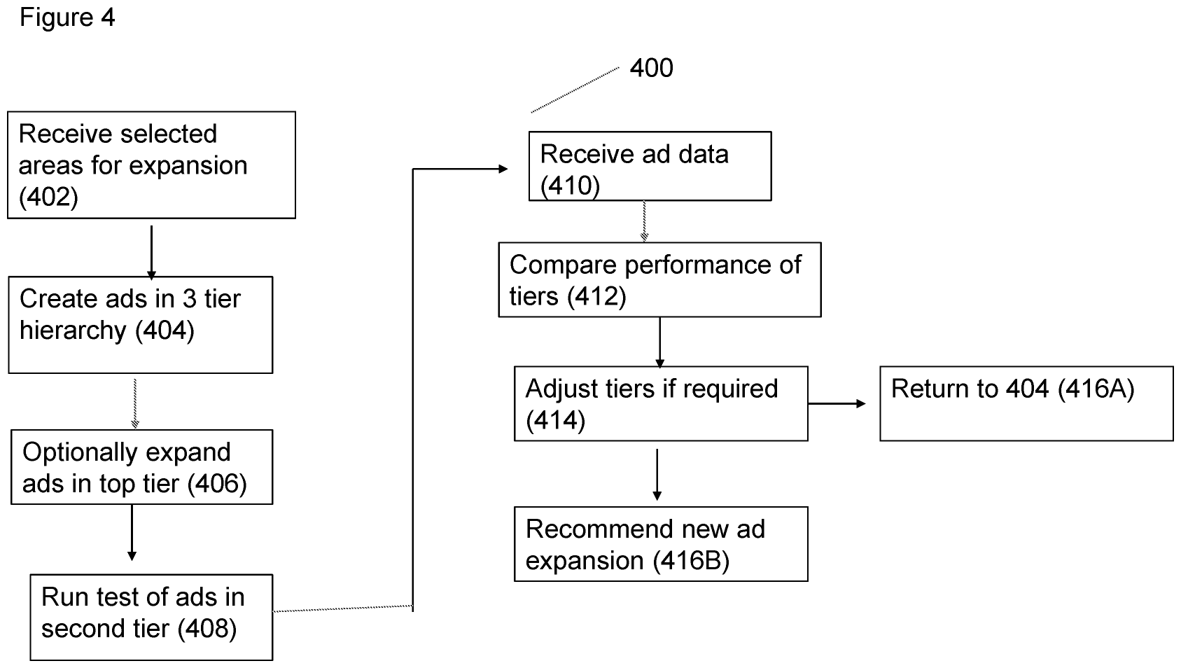

FIG. 4 relates to an exemplary, non-limiting detailed method for job posting expansion according to at least some embodiments. As shown in a method 400, the process starts at 402 by receiving selected areas for expansion, for example and without limitation job title, job description, job location and so forth. At 404, ads (job postings) are created in a three tier hierarchy. The top hierarchy relates to job postings that have either been shown to be successful or that are expected to be successful, for example for a new campaign of job postings. The second tier relates to experimental job postings, which have not yet been shown to be successful, or that are less expected to be successful. The third tier relates to job postings that are expansions of the job postings in the first tier.

At 406, optionally further expansions are performed of the job postings in the first tier. Alternatively, this step is skipped, or is combined with 404. At 408, the performance of the job postings in the second tier is monitored, optionally before the first tier job postings are run (to determine if any of the first and second tier postings should be swapped) or alternatively while all tiers are run collectively.

At 410 job posting performance information is received. The performance of the job postings in the various tiers is compared at 412. The job postings in the tiers are adjusted if required at 414, at which point the process returns at 416A to 404. Otherwise the process continues to recommend any new job posting expansions at 416B if necessary.

FIG. 5A relates to a non-limiting exemplary AI engine, which may be incorporated with the AI engine of FIG. 5B and which may also provide inputs to the analysis engine.

AI engine 506A is preferably incorporated within an AI system 500. AI engine 506A preferably comprises one or more ML (machine learning) algorithms 508. Non-limiting examples of such algorithms include random forest, k-nearest neighbor, XG boost, any suitable neural network, any suitable deep learning algorithm and a decision tree. Optionally a rule based engine may be used in place of one or more of the ML algorithms 508. AI engine 506A preferably receives ad (job posting) data inputs 502, optionally after processing by a data preprocessor 514.

The output of AI engine 506A preferably features job posting information 504, which may for example comprise one or more of job title, job description, job location, bidding information and/or publisher information, as described herein. Job posting information 504 may also comprise ad (job posting) expansion recommendations; however, preferably this is provided through the AI engine implementation of FIG. 5B. Job posting information 504 is preferably provided as an input to the AI engine implementation of FIG. 5B as described below.

FIG. 5B relates to an additional non-limiting exemplary AI engine, which may be incorporated with the AI engine of FIG. 5A and which may also provide inputs to the analysis engine. Components with the same reference numbers have the same or similar function, unless otherwise noted. Optionally, the output of the AI engine of FIG. 5A may be provided as an input to an AI engine 506B, shown as AI inputs 512. AI inputs 512 may comprise other types of inputs, additionally or alternatively. AI engine 506B is preferably incorporated in an AI system 550.

AI engine 506B preferably comprises a swarm algorithm 558. Swarm algorithm 558 may optionally comprise any suitable swarm intelligence analysis algorithm, including without limitation a bee swarm algorithm (for example Karaboga D. An Idea Based on Honey Bee Swarm for Numerical Optimization. Volume 200. Computer Engineering Department, Engineering Faculty, Erciyes University; Kayseri, Turkey: 2005. pp. 1-10. Technical report-tr06) or a wolf pack algorithm (for example “Wolf Pack Algorithm for Unconstrained Global Optimization”, by Hu-Sheng Wu and Feng-Ming Zhang, Mathematical Problems in Engineering, 2014).

The output of AI engine 506B is preferably job posting expansion recommendations 510.

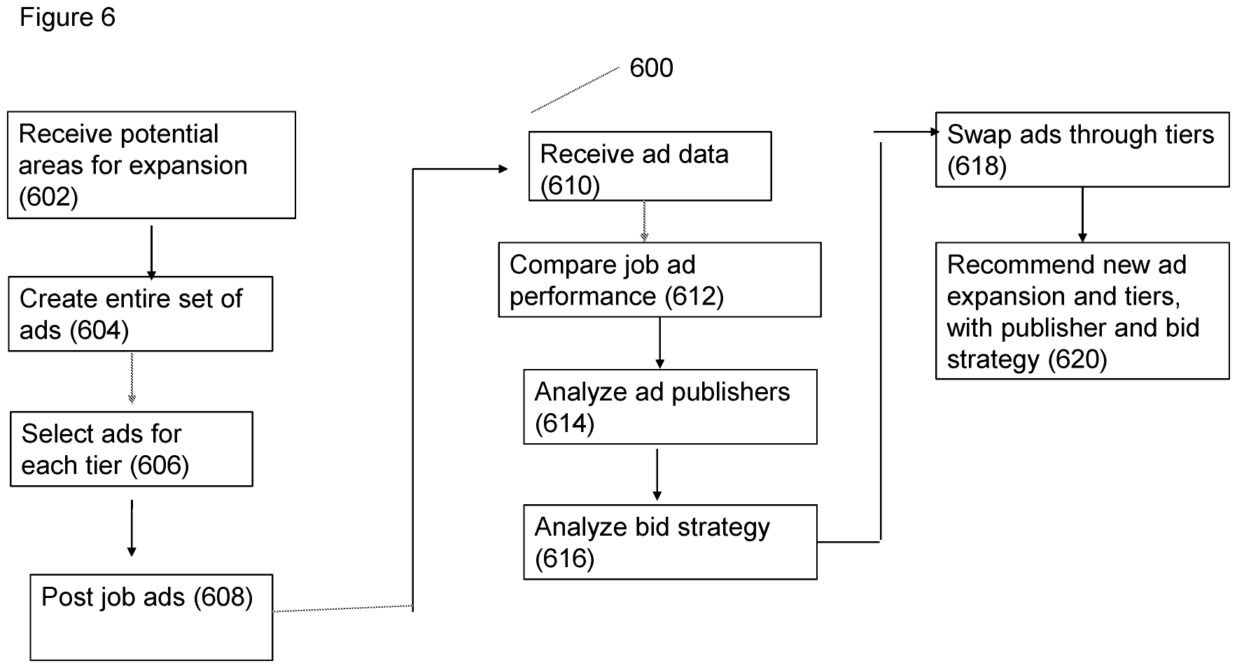

FIG. 6 relates to an exemplary, non-limiting method for creating an expanded set of hierarchically ordered job postings. As shown in a method 600, the process begins at 602, when a plurality of potential areas for expansion is received. The potential areas for expansion, as described herein, include but are limited to job posting location or geography, job title, job description, full vs part time and so forth. Optionally a selection of potential areas is received.

At 604, an entire set of ads (job postings) is created, according to adjustments to the areas for expansion to create more variations and/or by combining different variations from these potential areas to create a plurality of job postings. At 606, job postings for each tier are selected from the entire created set of job postings. For example and without limitation, if the “wolf pack” algorithm is implemented to create the hierarchy of job postings, then the alpha or top tier contains the selected job posting types, or example job postings, that are determined or considered to be best performing. For example, previous performance for the same or similar campaign may be considered. The beta tier would include those job postings or types of postings that are being tested or trialed. The gamma tier would include the expanded job postings that are related to the alpha tier job postings.

At 608, the job postings are published (posted), for example to job boards and other online locations for publishing such postings. At 610, data that results from such job posting publication (ad data) is received. For example and without limitation, such job posting data may relate to one or more of the number of impressions on the publication site, the relative location of the impressions on the publication site, the number of clicks, number of applicants, click to applicant ratio, click rate, applicant rate, cost per click, cost per applicant, number of hires, rate of hires, hire to applicant or hire to click ratio, and/or cost per hire. Next, the performance of different job postings after publication is compared at 612, for example to consider whether the beta tier job postings show a better performance than the alpha tier job postings. By “better performance” it is meant a performance, as demonstrated by the job posting data, which is considered to be a higher level, as determined according to preferred job posting data performance criteria. For example, performance may be determined according to the combination of clicks, applicants and hires, in comparison to the amount of money and/or time spent.

Optionally, performance of job postings at particular publishers is analyzed at 614, for example with regard to any of the above job posting results and/or including publisher specific criteria, including but not limited to one or more of number of impressions, relative placement on a job board page and/or within search results, and so forth. Optionally, performance of job postings with regard to a specific bid strategy is analyzed at 616, for example with regard to any of the above job posting results and/or including bid strategy specific criteria, including but not limited to hourly, daily, weekly budget considerations, time required per job applicant, cost required per job and so forth.

At 618, optionally the job postings (ads) are swapped through the tiers. For example, one or more beta tier job postings may be exchanged for one or more alpha tier job postings. If so, then preferably the associated expansions of the job postings of the beta tier job postings are swapped into the gamma tier, and the expansions associated with alpha tier job postings that are being removed are also in turn removed from the gamma tier.

At 620, optionally one or more new ad (job posting) expansion and tiers, with or without publisher and bid strategy, are recommended or generated, for example if the job posting performance data falls below a certain threshold level of performance.

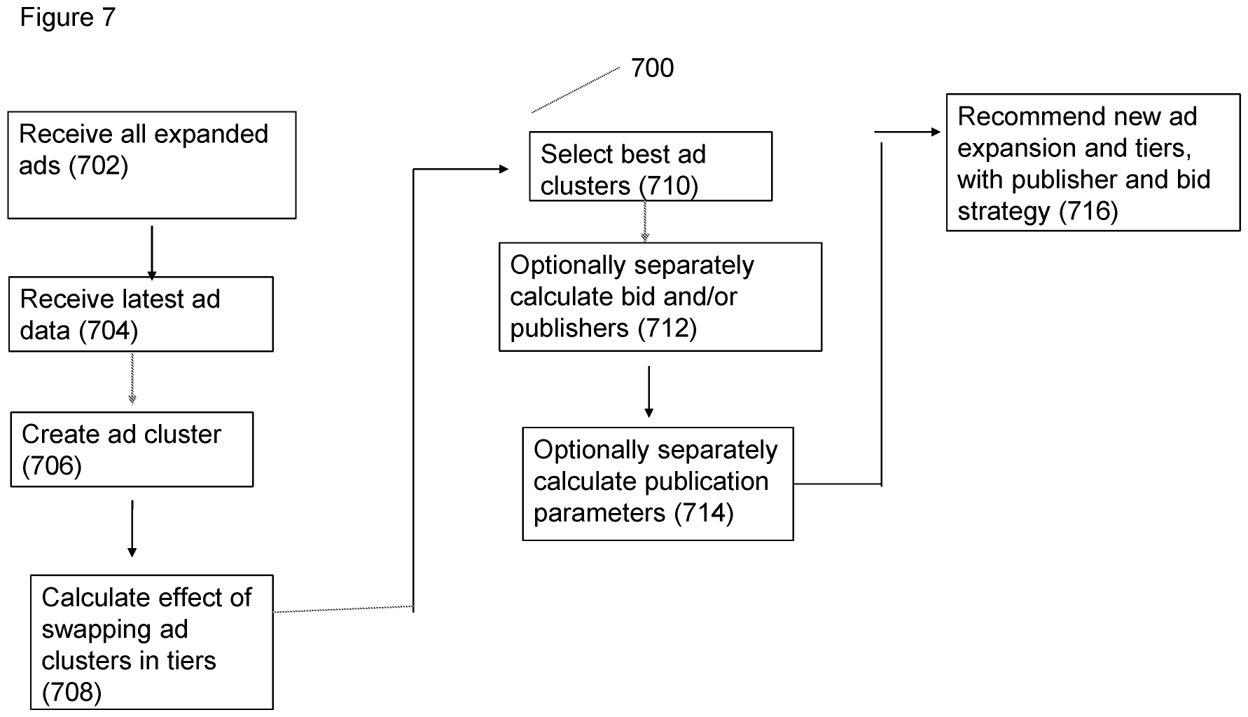

FIG. 7 relates to an exemplary, non-limiting method for arranging job postings within the hierarchy. In a method 700, the process starts when all expanded job postings are received at 702. The latest job posting data is then also received at 704, as described above, with regard to the performance of the published job postings. Next optionally a job posting cluster is created at 706, combining job title, location and text description, with bid strategy and publisher information. Multiple job posting clusters may contain or be associated with the same or similar job title, location and text description; conversely, multiple job posting clusters may also contain or be associated with the same or similar bid strategy and/or publisher information. Next, the effect of swapping ad (job posting) clusters in tiers, for example as described above, is calculated at 708.

The best job posting clusters are then selected at 710, according to these calculations. By “best” it is meant job posting clusters that are calculated or estimated to have the best performance, as previously defined. Optionally the bid strategy and/or publisher strategy are separately calculated at 712, if one or both has not been calculated or estimated as part of the job posting cluster. Optionally the publication parameters are separately calculated at 714, if these parameters have not been calculated or estimated as part of the job posting cluster, and/or as part of the calculation or estimation at 712. At 716, optionally new ad (job posting) expansion and tiers, with publisher and bid strategy, are recommended or generated, for example if the job posting performance data falls below a certain threshold level of performance.

FIG. 8 relates to an exemplary, non-limiting method for creating multiple job postings. In a method 800, the process starts by creating a set of geographical locations for each job at 802. Geographical locations may for example relate to city and/or state, zip code, county or parish, metropolitan area, location near or at a transportation artery or hub, location at or near a particular industrial area or office park, and so forth. Job title synonyms are then created at 804, for example with regard to the job role (secretary, warehouse worker, and so forth); and/or function (heavy lifting, clerical, and so forth).

Job title add-ons may then optionally be created at 806, such as for example with regard to salary (“Earn up to $XX/hr”); encouraging descriptors (“Immediate opening”, “No experience needed”, “Multiple shifts available”, “Benefits included”, “start earning”); full vs part time and so forth.

At 808, the results from steps 804 and 806 are preferably combined to create the final job titles for the job postings. Optionally the geographical location information from 802 may also be combined to the final job titles. The job posting text (description) options are then created at 810, for example to expand on one or more aspects of the job title and/or add-ons, other information regarding location and so forth. At 812, the job titles and job descriptions are combined to form the job postings. Optionally, the combined job postings are reviewed and weighted according to historical data at 814.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for optimizing published job postings, the system comprising:
a user computational device for sending one or more job posting parameters, including a plurality of job title synonyms and job text descriptions;
a server gateway for receiving said one or more job posting parameters, and
a computational network for connecting said user computational device and said server gateway;
said server gateway comprising an analysis engine for creating a plurality of different job postings from said job title synonyms and job text descriptions, and for sorting said different job postings according to one or more job posting performance criteria in a plurality of tiers, wherein job postings in each tier comprise a core job posting and a plurality of related expanded job postings;
wherein said server gateway transmits said core and related job postings in at least the highest tier, for publication at a job posting publisher;
wherein said server gateway receives job posting performance data from said job posting publisher and swaps at least one core job posting from said lower tier to said higher tier according, including swapping said related expanded job postings, and transmits said new core and related expanded job postings to said job posting publisher.

2. The system of claim 1, wherein said user computational device supplies said related expanded job postings according to one or more of job title and synonyms, job description, geographical location, full/part-time in title, and encouraging words in said job title.

3. The system of claim 1, wherein said analysis engine creates said related expanded job postings according to one or more of job title and synonyms, job description, geographical location, full/part-time in title, and encouraging words in said job title.

4. The system of claim 3, wherein said analysis engine further determines a bid strategy and a publication strategy for each of said core and related expanded job postings; wherein said bid strategy and said publication strategy are associated with each core job posting, and hence through said related expanded job postings associated with said core job posting, to form a job posting cluster.

5. The system of claim 4, wherein said server gateway receives job posting performance data from said job posting publisher according to said job posting clusters and swaps said job posting clusters.

6. The system of claim 5, wherein said analysis engine determines a bid strategy for each job posting cluster separately.

7. The system of claim 6, wherein said tiers are determined according to a swarm algorithm by said analysis engine.

8. The system of claim 7, wherein said swarm algorithm is selected from the group consisting of a wolf pack algorithm and a bee swarm algorithm.

9. The system of claim 3, wherein said analysis engine further comprises a machine learning algorithm for receiving historical job posting performance data and for determining said related expanded job postings according to said historical job posting performance data.

10. The system of claim 1, wherein said server gateway comprises a memory and a processor, wherein said memory is configured for storing a defined native instruction set of codes and said processor is configured to perform a defined set of basic operations in response to receiving a corresponding basic instruction selected from the defined native instruction set of codes stored in said memory, wherein said memory stores a first set of machine codes selected from the native instruction set for receiving said job posting performance data through said server interface and a second set of machine codes selected from the native instruction set for operating an analysis engine to swap said core and expanded job postings according to said job posting performance data.
